(19) United States
(12) Patent Application Publication
(10) Pub. No.: US 2013/0082504 A1
(43) Pub. Date: Apr. 4, 2013

(54) MODULAR SEAT ASSEMBLY

(71) Applicant: Etienne ARCHAMBAULT, Sherbrooke (CA)

(72) Inventor: Etienne ARCHAMBAULT, Sherbrooke (CA)

(73) Assignee: BAULTAR I.D. INC., Val Joli (CA)

(21) Appl. No.: 13/409,582

(22) Filed: Mar. 1, 2012

Related U.S. Application Data
(60) Provisional application No. 61/540,689, filed on Sep. 29, 2011.

(51) Int. Cl. B60N 2/68; B60N 2/46; B60N 2/48; B60N 2/44

(52) U.S. Cl. 297/452.18; 297/452.1; 297/452.39

(57) ABSTRACT

A modular seat assembly comprising a plurality of modules easily interchangeable and connected together with mounting interfaces. More particularly, the modular seat assembly comprises a mounting group comprising modules designed for mounting the seat assembly preferably to a vehicle cabin; and a seat group comprising modules designed for assembling an upper seat connectable to the modules of the mounting group. Each module has an independent structural function and is removably connected to the modular seat assembly via its mounting interface, which can include an anti-wobbling fastening mechanism. The independent structural function of module can thus affect the final functionality of the seat assembly.

### RELATED APPLICATION

This application claims the benefit of U.S. Provisional Application No. 61/540,689 filed on Sep. 29, 2011 and entitled “Modular Seat Assembly”. The above patent application is incorporated herein by reference in its entirety.

### FIELD OF THE INVENTION

The present invention relates to a modular vehicle seat assembly for being used in heavy transport, such as in railroad freight or transit, for example. More particularly, there is provided a seat assembly comprising independent and interchangeable modules, which are adaptable to various configurations of a vehicle cabin.

### BACKGROUND OF THE INVENTION

In the field of modular seat assemblies, vehicle seats typically attach to the cabin of the vehicle via two configurations: they are either mounted to the floor of the cabin (“floor-mounted”), or mounted to the wall of the cabin (“wall-mounted”). These configurations often come with optional accessories such as headrests, footrests, armrests, etc.

U.S. Pat. No. 5,374,102 granted to Archambault et al. describes a floor-mounted seat assembly for use in a vehicle. The seat assembly is floor-mounted via a height adjustable base. The seat is provided with an armrest, a backrest and a footrest, all of which are adjustable in relation to the base. The seat assembly comprises several functional options.

U.S. Pat. No. 5,118,062 also granted to Archambault describes a seat-attachment assembly for wall-mounting a vehicle seat. The assembly has an elongated rail member rigidly fixed in a horizontal position onto a vertical wall, and a seat carrier slidably mounted onto the rail member.

U.S. Pat. No. 6,554,365 to Karschin et al. describes a motor vehicle seat. Part of the seat structure has a frame which encloses a construction space within which a module for optionally receiving subassemblies is arranged.

U.S. Pat. No. 7,857,259 to Batz et al. describes a modular seat system for a vehicle in an aircraft The system has at least one seat, and the seat includes: a seat unit with a seating element and a seat back, a seat frame with a pair of vertical support elements at whose upper end a bearing structure is arranged on which the seat unit rests, and a fixing structure in the floor of the cabin.

The Applicant is also aware of the following U.S. patent documents: 2005/0082896; 2005/0200179; 2008/0048066; 2009/0189433; 2010/0109415; 2010/0207431; 2010/0320826; 2011/0029123; 2011/0037304; 2011/0068226; 2011/0101165; 2011/0133533; U.S. Pat. Nos. 3,785,600; 5,671,976; 6,264,180; 7,469,861; 7,814,636; and 7,883,149.

Also known are some of the disadvantages associated with conventional systems. For example, existing modular seat assemblies have a limited number of configurations (i.e. either floor-mounted or wall-mounted), which do not facilitate sufficient modularity. Additionally, known modules are often complex to assemble, difficult to interchange, and do not include simple and easy-to-assemble interfaces. Such modularity and changeability is important because each driver and his/her's working conditions have specific needs within the design limits of the vehicle cabin. Therefore, the ability to adapt a seat system to provide, say, armrests and fore-aft movement for some driver's working conditions, while removing such functionality for others, is highly desired. Conventional systems often do not provide such adaptability, and there is thus a need for a large variety of customizable functional options so as to provide adequate ergonomics to a seat assembly.

An additional disadvantage is that existing seat assemblies often have a plurality of functions, where each function is accomplished through the junction of two modules. This dependence on two modules increases both the complexity and the cost of maintenance operations such as replacement of modules. It may therefore be difficult to find a new module compatible with an older, existing module, with the result that the operator may have to replace two modules rather than one to keep the corresponding function of the seat.

One important issue in vehicle transportation is the limitation of the wobbling and shaking of the vehicle seat, which can cause inconvenience and pain to the driver. Conventional modular assemblies do not adequately address this issue.

A further disadvantage resides in potential inventory problems caused by traditional modular assemblies because of their poor modularity. During maintenance operations, a large amount of seats with different configurations have to be stocked in order to provide replacement pieces adapted to the wide variety of different vehicle cabin configurations. Existing seats are maintained by replacing parts, modules or the complete seat, which increases inventory costs and other related expenses.

There is thus a need for a modular seat assembly offering a larger number of possible configurations, which by virtue of its design and components would be able to overcome or at least minimize some of the above-mentioned drawbacks.

### SUMMARY OF THE INVENTION

The object of the present invention is to provide a modular vehicle seat assembly comprising a plurality of modules easily interchangeable and rapidly connected together via mounting interfaces, with some of these interfaces being anti-wobbling interfaces, therefore satisfying at least some of the above-mentioned needs.

According to the present invention, there is provided a modular seat assembly for providing an independent functional partitioning of a modular seat in a vehicle cabin, the modular seat assembly comprising a mounting group of modules and a seat group of modules, the mounting group comprising modules being configured for being mounted to the vehicle cabin, and the seat group comprising modules being configured for assembling the modular seat, the seat group being connectable to the mounting group, each module having an independent function and comprising a mounting interface removably connecting each module to an adjacent module, wherein the modular seat assembly has a final functionality defined by a combination of the independent function of each module.

In a preferred embodiment of the modular seat assembly, each module in the mounting group and in the seat group has an independent structural and/or ergonomic function, and is also and easily removable and connectable to another module or the modular seat assembly via an interface.

According to another preferred embodiment, the mounting group includes a wall-mounting module which connects to the vehicle wall, thus allowing for a configuration where the modular seat assembly is wall-mounted. The mounting group also includes a floor-mounting module which connects to the vehicle floor, thus allowing for a configuration where the modular seat assembly is floor-mounted.

Preferably, the mounting interface of each module has is defined by at least one planar surface kept in contact with a corresponding planar surface via standard bolting components which simplifies assembly and disassembly of the module to a corresponding element, and which improves the rapidity with which the module can be installed.

According to another preferred embodiment, the mounting interface could facilitate and secure the connection of the modules to each other, so as to significantly reduce and practically eliminate wobbling by using an anti-wobbling fastening mechanism. Such an anti-wobbling fastening mechanism preferably consists of a secondary interface being perpendicular to the planar surface of a corresponding mounting interface, the secondary interface connecting to the corresponding mounting interface via at least one fastener.

According to another preferred embodiment, the mounting group can include means for adjusting the height of the modular seat assembly, for allowing the foot to rest comfortably, and to position the seat either via rotation or longitudinally.

### BRIEF DESCRIPTION OF THE DRAWINGS

These and other objects and advantages of the invention will become apparent upon reading the detailed description and upon referring to the drawings in which:

FIG. 1 is a front view of a seat group of modules, according to a preferred embodiment of the present invention.

FIG. 2 is a side view of a mounting group of modules, according to a preferred embodiment of the present invention.

FIG. 3 is a perspective view of a wall-mounting assembly, according to a preferred embodiment of the present invention.

FIG. 4 is a perspective view of a tripod module of the wall-mounting assembly of FIG. 3.

FIG. 5 is a perspective view of a tripod mounting module of the wall-mounting assembly of FIG. 3.

FIG. 6 is a perspective view of a seat-supporting module, according to a preferred embodiment of the present invention.

FIG. 7 is a perspective view of a floor-mounting module, according to a preferred embodiment of the present invention.

FIG. 8 is an exploded view of a seat group of modules, according to a preferred embodiment of the present invention.

FIG. 9 is a bottom view of a cushion component, according to a preferred embodiment of the present invention.

FIG. 10 is a top view of a backrest frame module, according to a preferred embodiment of the present invention.

FIG. 11 is a perspective view of a backrest frame module provided with an armrest module, according to a preferred embodiment of the present invention.

FIG. 12 is a side view of a mounting group of modules provided with a footrest module, according to a preferred embodiment of the present invention.

FIG. 13 is a perspective view of a headrest module, according to a preferred embodiment of the present invention.

### DETAILED DESCRIPTION OF THE INVENTION

In the following description, the same numerical references refer to similar elements. Furthermore, for the sake of simplicity and clarity, namely so as not to unduly burden the figures with several reference numbers, only certain figures have been provided with reference numbers, and components and features of the present invention illustrated in other figures can be easily inferred therefrom. The embodiments, geometrical configurations, and/or dimensions shown in the figures are preferred for exemplification purposes only.

Moreover, although the present invention was primarily designed for a modular seat assembly mountable in a vehicle cabin, for example, it may also be mountable to other devices or in other fields, as apparent to a person skilled in the art. For this reason, expressions such as “vehicle”, “seat”, “locomotive”, etc., as used herein should not be taken as to limit the scope of the present invention and includes all other kinds of transportation means, materials, objects and/or purposes with which the present invention could be used and may be useful. The present invention therefore encompasses any assembly resulting from the mounting of a plurality of modules, each module having an independent function among the assembly.

Moreover, in the context of the present invention, the expressions “modular”, “changeable”, “replaceable”, “adaptable”, and “configurable”, as well as any other equivalent expressions and/or compounds word thereof known in the art, will be used interchangeably, as apparent to a person skilled in the art.

In addition, although the preferred embodiment of the present invention as illustrated in the accompanying drawings comprises various components and although the preferred embodiment of the modular seat assembly as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the modular seat assembly, and corresponding parts, according to the present invention, as briefly explained and as can easily be inferred herefrom by a person skilled in the art, without departing from the scope of the invention.

The modular seat assembly (or simply “seat assembly”) according to the present invention includes a plurality of modules. The term “modular”, as used herein, is understood to explain the functionality of the seat assembly and its components, and the advantages provided thereby. More specifically, the term “modular” implies the use of “modules”, which are understood to be a set of components of the seat assembly that are standardized and/or independent, and which can be used to construct a more complex structure such as the seat assembly itself, for example. These modules can be installed, removed, and/or replaced without affecting the installation or configuration of adjacent modules, thus facilitating maintenance, assembly, and disassembly operations.

The modular seat assembly provides an independent functional partitioning of a modular seat in the vehicle cabin. A person skilled in the art understands “independent functional partitioning” to refer to the modules of the seat assembly, each module providing a separate function independent from other adjacent modules. Each module is also easily installed, removed, and replaced, irrespective of its relationship with an adjacent module and/or the seat assembly itself, and is thus understood to be capable of being “partitioned”.

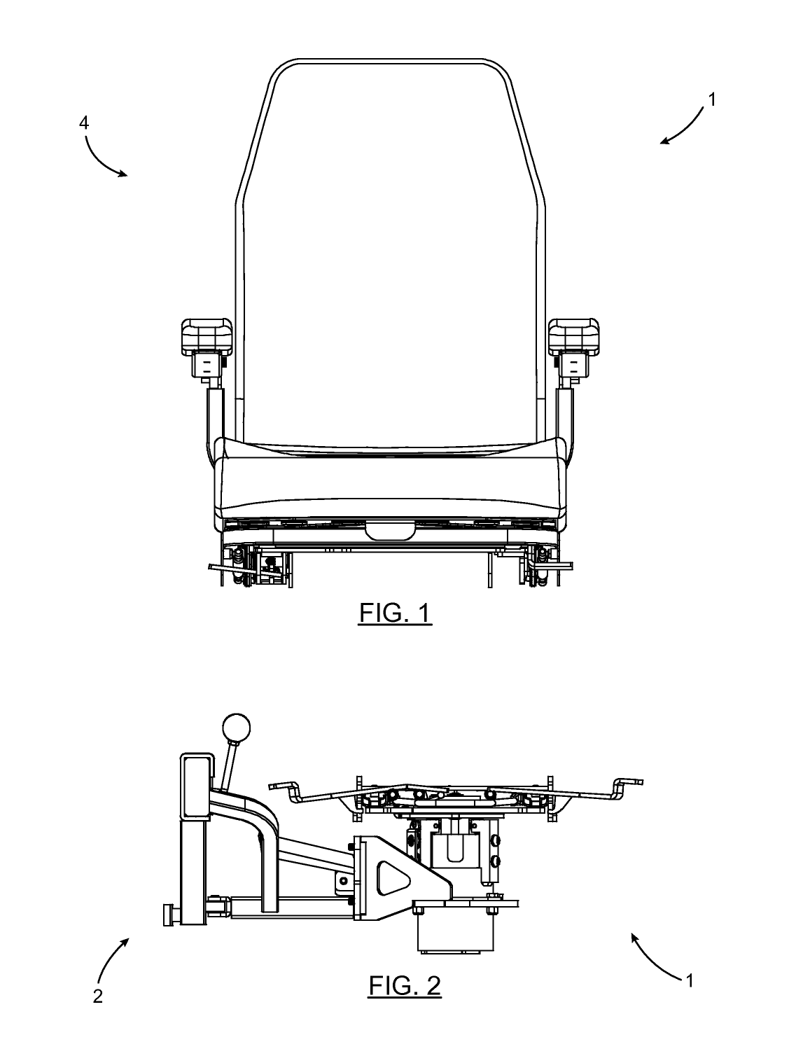

As shown in FIGS. 1 and 2, these modules of the seat assembly 1 belong to one of two groups: either the mounting group of modules 2 (or simply “mounting group”), or the seat group of modules 4 (or simply “seat group”). The mounting group 2 includes modules, as described below, which facilitate the mounting of the seat assembly 1 to the vehicle cabin, preferably either to the wall of the cabin (known as the “wall-mounted configuration”) or to its floor (known as the “floor-mounted configuration” or “pedestal configuration”). The seat group 4 has modules which are designed for assembling the vehicle seat, which is modular. The seat group 4 connects to the mounting group 2, thereby forming the seat assembly 1. The connection is preferably done by mechanical means, as further explained below.

Each of the modules has an independent function, which will be further discussed below in connection with the modules themselves. By “independent function”, it is mainly understood that each module can accomplish at least one unique and distinct ergonomic and/or human-to-product interaction (i.e. a backrest frame module for adjusting the tilt angle as per the needs of the operator, etc.). In a preferred embodiment, each module has different configurations which define at least one ergonomic function. Therefore, it is understood that two modular seat assemblies, for example, may include the same module, but in each modular seat assembly, the module has a different configuration and provides a different ergonomic function (i.e. in one seat assembly, the backrest frame module adjusts the tilt angle in response to the operator's input, whereas in the other seat assembly, the backrest frame module has a fixed angle). Thus, it is apparent how the different configurations of the module in question can confer a specific choice of ergonomic function to the modular seat assembly, depending on the client and/or driver's requirements.

Each module is also provided with a mounting interface, which allows each module to removably connect to the seat assembly 1 and/or another module or components. By “removably connect”, it is understood that each interface is a simple and easily manipulated component which helps the corresponding module to be easily both connected to, and removed from, another component. The modules themselves are preferably easily interchangeable at their interfaces. Preferably, each mounting interface consists of at least one planar surface. This planar surface can interact with a corresponding planar surface of another mounting interface so that the modules to which these mounting interfaces are attached can connect or “mate” appropriately. Of course, it is understood that the mounting interfaces are not limited to planar surface, and that other simple forms of mating surfaces that would further simplify the mating are also within the scope of the invention. The planar surfaces described herein can provide the simplest mating, especially when shear forces in the plane of the surface are kept low or non-cycling. As but one non-limitative example, the mounting interfaces can consist of a set of many parallel planes having fastener geometries so as to fix on adjacent planes.

As an example of the movements of two mating planar surfaces relative to each other, consider that a given mounting interface (and thus its attached module) has six degrees of freedom (DOF) with respect to a corresponding mounting interface. Three of these DOF are in translation, and the other three DOF are in rotation. A mechanical fastener, preferably a bolting fastener, which has corresponding contact surfaces, can firmly lock one of the three DOF in translation, and two of the three DOF in rotation. The translation DOF locked by the bolt is in the axial direction of the bolt. The two rotational vectors of the rotation DOF locked by the surfaces kept in contact by the bolt are in the two orthogonal directions which define the 2-D plane of the mounting interface. However, even a set of bolts on a pair of planar surfaces in contact with each other will not lock the remaining two translations and one rotation DOF because the holes for these bolts are always larger than bolts themselves. Therefore, oscillatory shear forces in these DOF may generate looseness and a resultant wobbling motion.

In the seat environment, the remaining DOF which causes most wobbling occurrences is the sole remaining rotation DOF. To lock this DOF and thus maximize the anti-wobbling effect of the mounting interfaces experiencing the most shear oscillatory forces, a second set of paired planar surfaces kept in contact with at least one mechanical fastener, again preferably a bolting fastener, is added to firmly lock one additional translation DOF in the axial direction of the additional bolt, and the one remaining rotation DOF. A mounting interface with this additional characteristic is designated herein as an “anti-wobbling interface” of a module. This additional characteristic of the interface is also referred to herein as an anti-wobbling fastening mechanism.

The combination of individual modules confers a final functionality to the seat assembly 1. This final functionality can depend on the particular modules used in the seat assembly 1 and/or their configuration. By “final functionality”, it is understood that the combination of modules results and/or achieves an ultimate desired function. As but one non-limitative example, if the desired final functionality of the seat assembly 1 is to mount it to the vehicle cabin wall, then the seat assembly 1 can consist of a combination of modules such as the tripod module and the tripod mounting module because the functions associated with these modules allows the seat assembly 1 to be wall-mounted. If, according to another non-limitative example, the desired final functionality of the seat assembly 1 is to be floor-mounted, then the combination of modules can be the seat-supporting module and the floor-mounting module because these modules each function to allow the seat assembly 1 to be floor-mounted.

Attention is now drawn to the specific modules of the seat assembly 1, which, as mentioned previously, belong to either the mounting group 2 or the seat group 4. Referring now to the mounting group 2, the modules of this group preferably number four, all of which are inter-connectable, and which allow the seat assembly 1 to achieve the final functionality of being wall-mounted or floor-mounted. Choosing between a wall-mounted and a floor-mounted configuration depends on many factors such as, but not limited to, vehicle cabin constraints, vehicle type, passenger requirements, etc., as apparent to a person skilled in the art.

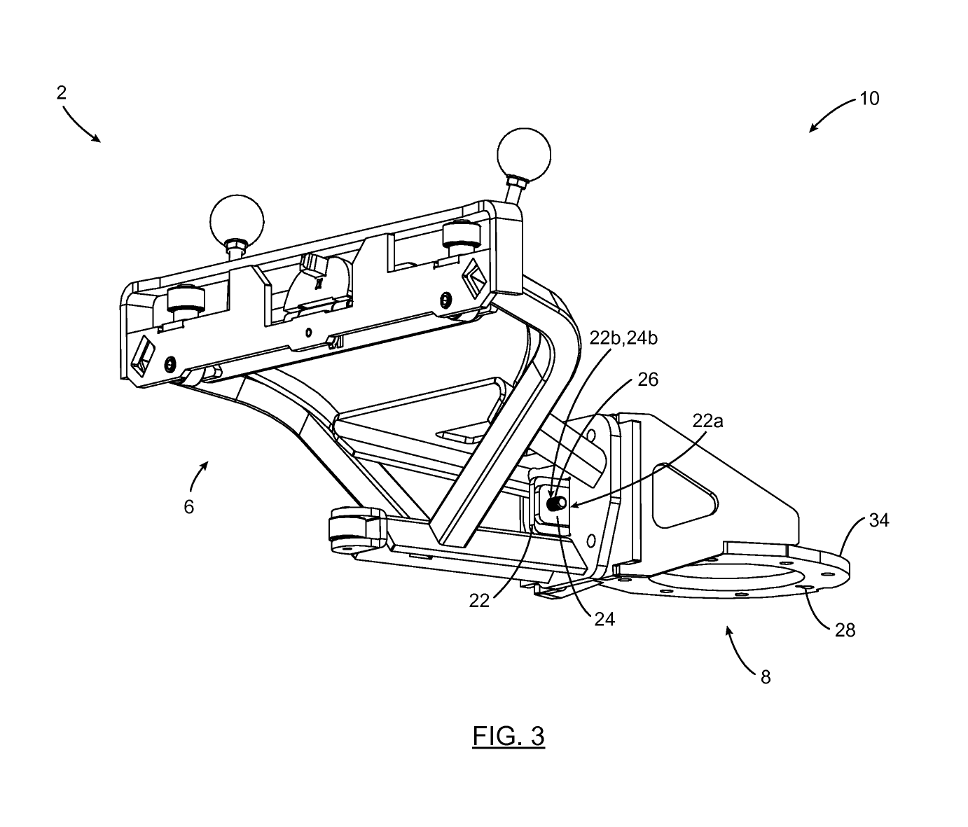

Referring to FIGS. 3 to 5, the first of these modules is a tripod module 6. The tripod module 6 preferably has the function of facilitating the mounting of the seat assembly onto a vehicle cabin wall. A second of these modules is the tripod mounting module 8, which is connectable to the tripod module 6, as exemplified in FIG. 3. The tripod mounting module 8 is preferably configurable in height and in wall-to-seat distance according to the requirements of the cabin environment. As but one example, the tripod mounting module 8 should be designed and selected depending on the seat positioning needs in respect to the wall of the cabin. The tripod mounting module 8 preferably has the function of connecting the tripod module 6 to the seat-supporting module and/or another seat-related module, thereby allowing the vehicle seat to be wall-mounted. The combined connection of the tripod module 6 with the tripod mounting module 8 preferably provides a wall-mounting assembly 10 as shown seen on FIG. 4, and allows for the wall-mounted configuration. The wall-mounting assembly 10 is preferably mounted to the cabin wall, thus securing the seat assembly 1 thereto, and supporting the weight of the seat assembly 1, and the passenger seated therein. The wall-mounting assembly 10 is preferably designed to connect to a seat-supporting module, which in turn connects to the seat group, as further explained below.

The tripod module 6 preferably includes a first mounting interface 18, which connects with a second mounting interface 20 of the tripod mounting module 8. In order to minimize wobbling in the wall-mounting assembly 10, the first and second mounting interfaces 18, 20 can be connected by means of an anti-wobbling interface as further described below. The use of standard mechanical fasteners, such as standard bolts, advantageously facilitates the simplicity of the connection between the two interfaces. One non-limitative example of such a standard fastener is a fastener having a geometry or head configuration that is hard to access and manipulate without appropriate tools, thereby reducing the likelihood that the fastener would be tampered with by vandals, thieves, or by others making non-approved modifications. These standard fasteners are thus referred to as “tamper-proof” or “tamper-resistant”.

According to another preferred embodiment, the first mounting interface 18 has a protrusion 22 projecting perpendicularly from the first mounting interface 18. The same first mounting interface 18 is provided with a slot 22a. The second mounting interface 20 is provided with another protrusion 24. When mounting interfaces 18, 20 (and their corresponding modules) are connected together, the protrusion 24 is inserted within the slot 22a. The protrusions 22, 24 have notches 22b, 24b which are aligned upon connection. The connection between the mounting interfaces 18, 20 is further secured by inserting a bolt 26 through notches 22b, 24b. The bolt 26 is preferably disposed perpendicularly to the projecting direction of the protrusions 22, 24 and parallel to the plane defined by interfaces 18, 20, so as to stabilise the connection of the two interfaces 18, 20. This overall interface connection is configured to maximize the anti-wobbling effect according to the principles described above. This protrusions/slot connection, when used in conjunction with the simpler planar interface described above, may be thus designated an “anti-wobbling interface”. Of course, it is understood that the illustrated configuration of the protrusions/slot is not !imitative, and any other similar mechanical connection for the two interfaces is within the scope of the present invention. As but one example of such an alternate configuration, the protrusions/slot can be reversed, with the slot disposed on the second mounting interface 20.

According to another preferred embodiment, the first and second mounting interfaces 18, 20 are further firmly secured by a plurality of bolts and/or other mechanical fasteners inserted into a plurality of holes 28 provided on both interfaces 18, 20. Furthermore, the tripod module 6 can include a sliding component 30 installable into a wall track affixed to the vehicle cabin wall, or to a seat-supporting module fore-aft track, therefore enabling the wall-mounting assembly 10 (and thus the attached vehicle seat) to slide along the vehicle cabin wall, permitting longitudinal positioning. Preferably, the sliding component 30 of the tripod module 6 is inserted into the wall track before connecting the tripod mounting module 8 thereto. The sliding of the wall-mounted assembly 10 enables the assembled seat to be stable while having a position that can vary from the front of the vehicle to the back.

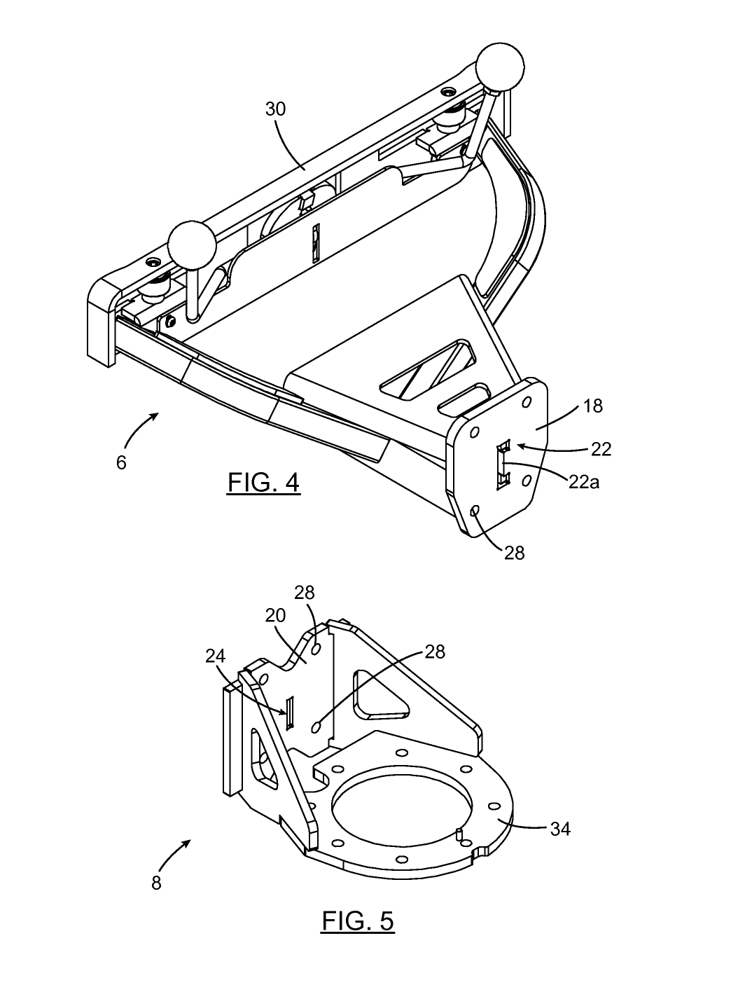

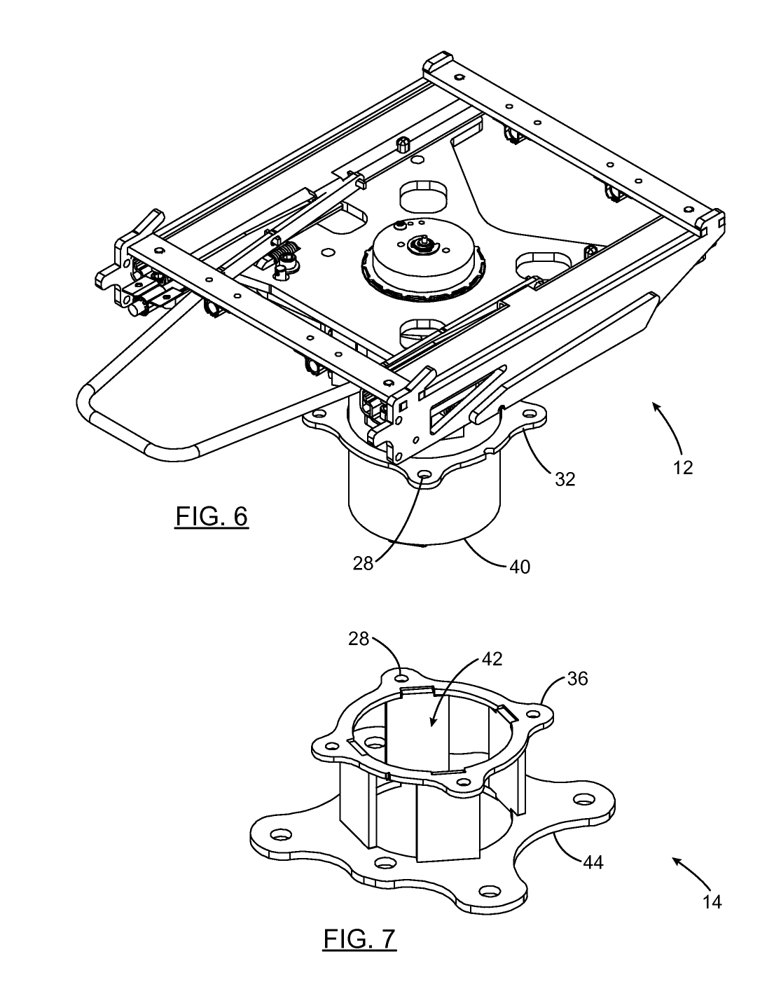

According to another preferred embodiment, and as shown in FIGS. 6 and 7, a third of these modules is the seat-supporting module 12. The seat-supporting module 12 preferably has the functionality of providing support for the vehicle seat. The seat-supporting module 12 can have a mounting interface 32 designed to connect with another mounting interface 34 of the tripod mounting module 8 (see FIGS. 3 and 5). These mounting interfaces 32, 34 are secured firmly together with bolts inserted in holes, or by other mechanical fasteners, as described above for the first and second mounting interfaces.

A fourth and final of these modules of the mounting group is the floor-mounting module 14. The floor-mounting module 14 preferably has the functionality of facilitating the mounting of the seat assembly to the floor of the cabin. The floor-mounting module 14 preferably connects to the seat-supporting module 12. The pedestal or floor-mounted configuration of the seat assembly can be achieved by connecting the seat-supporting module 12 to the floor-mounting module 14. As with the wall-mounted configuration, this is preferably achieved with a first mounting interface 36 provided on the floor-mounting module 14. This first mounting interface 36 can be connected to the mounting interface 32 of the seat-supporting module 12, thereby vertically linking the seat-supporting module 12 with the floor-mounting module 14. These modules 12,14 can then be firmly secured together with bolts inserted in a plurality of holes 28 provided on both mounting interfaces 32, 36, as described above. According to a preferred embodiment, the seat-supporting module 12 has a cylindrical base 40 designed to be fitted into a correspondingly shaped receiving area 42 of the floor-mounted module 14. Furthermore, the floor-mounted module 14 can have a second mounting interface 44 for connecting directly against the floor of the vehicle cabin.

It is thus understood that in both the wall-mounted and floor-mounted configurations mentioned above, the seat-supporting module 12 is preferably present, and can therefore be adapted to cooperate with either the wall-mounting assembly 10 or the floor-mounting module 14, or both.

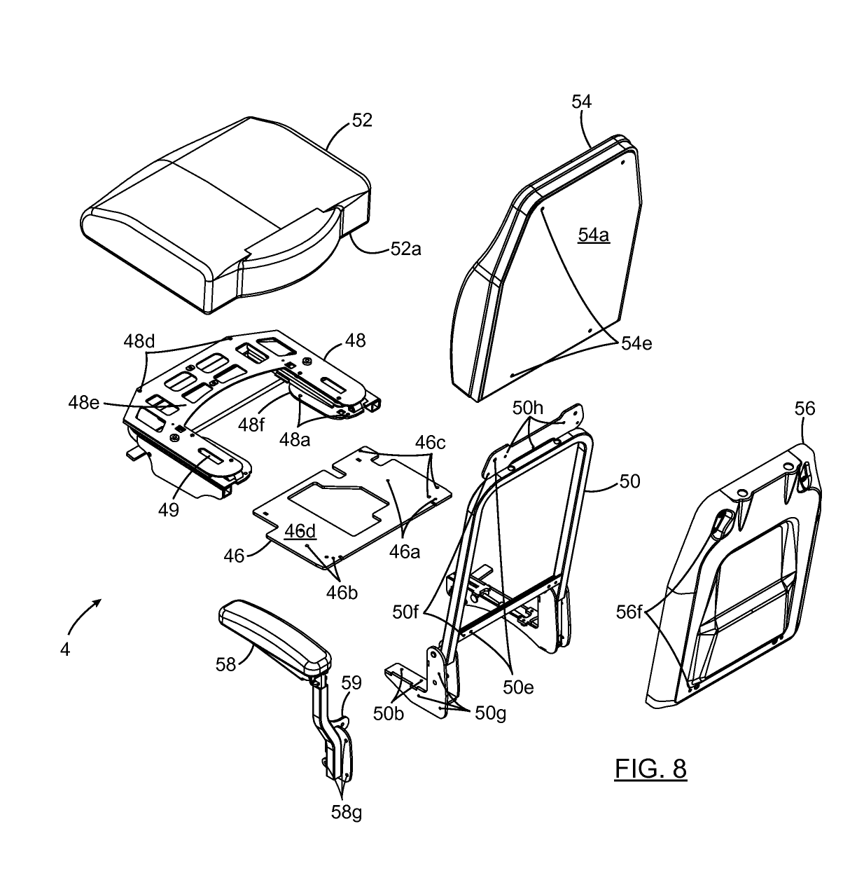

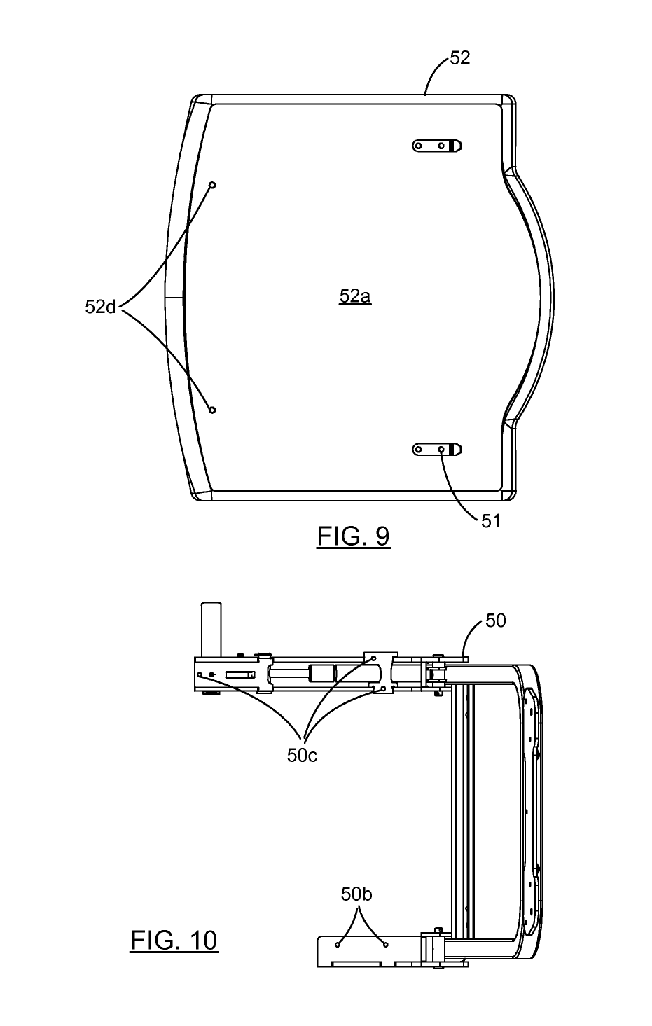

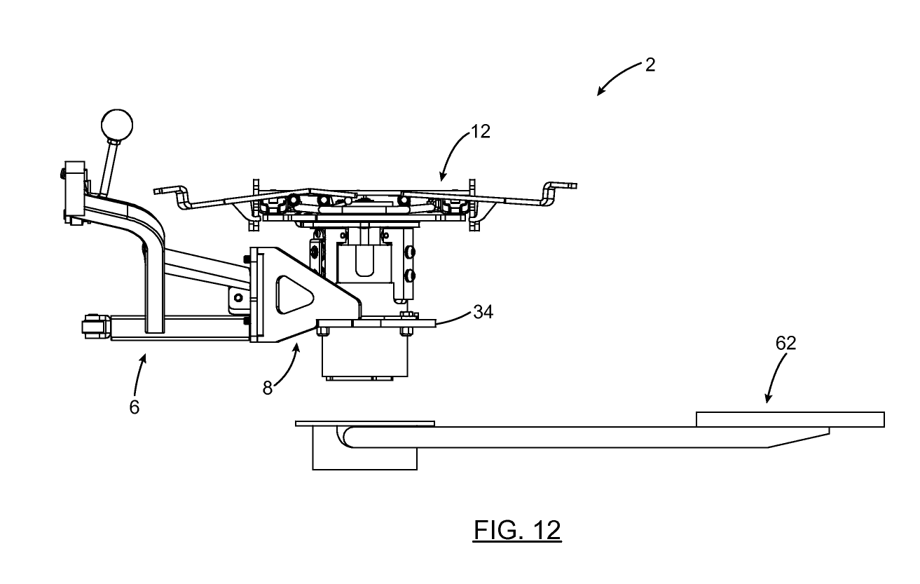

Having described the modules of the mounting group 2, reference is made to FIGS. 8 to 12 and to the modules of the seat group 4, as described below.

Referring to FIGS. 8 to 10, the seat group 4 comprises a plurality of modules which, when combined, preferably form a vehicle seat mountable on the mounting group, in both the wall-mounted and floor-mounted configurations.

The seat group 4 preferably includes three structural base modules: a platform 46, a seat frame module 48, and a backrest frame module 50. The platform 46 preferably provides the functionality of providing structural support to the seat group 4, and provides the base to which the seat frame module 48 and the backrest frame module 50 are connectable.

The platform 46 can have an upper surface 46d connectable to a lower surface 48f of the seat frame module 48. Preferably, the platform 46 is provided with a first set of symmetrical holes 46a and the seat frame module 48 with a corresponding set of symmetrical holes 48a. As apparent to a person skilled in the art, the holes 46a, 48a are preferably aligned, thus aligning the platform 46 and the seat frame module 48, so that the platform 46 and the seat frame module 48 can be secured together via bolts inserted and tightened through the holes 46a, 48a. More preferably, the set of holes 46a, 48a consists of four matching holes. The seat frame module 48 has the functionality of supporting a seat cushion attached thereto and to allow manual adjustment of its tilt angle and depth position.

The backrest frame module 50 can also be connected to the platform 46, preferably to an opposite site of the platform 46 as that side to which the seat frame module 48 is connected. Preferably, the backrest frame module 50 has the functionality of supporting a backrest cushion attached thereto and to allow manual adjustment of its tilt angle.

Advantageously, this connection can be achieved independently of the seat frame module 48, meaning that the backrest frame module 50 can be configured to connect directly to the platform 46. Preferably, the platform 46 is provided with second and third sets of holes (46b, 46c) which can respectively connect via bolts or other mechanical fasteners to corresponding first and second sets of holes (50b, 50c) provided on each of the two sides of the backrest frame module 50. More preferably, each of the sets of holes (46b, 50b) consists of at least two holes and each of the set of holes (46c, 50c) consists of at least three holes.

According to another preferred embodiment, the seat group 4 further includes the following comfort modules: a seat cushion 52, a backrest cushion 54, and a backrest shell 56. As apparent to a person skilled in the art, the functionality of these comfort modules preferably to provide comfort to the passenger seated in the vehicle seat at various contact points between the seat and the passenger's body.

The seat cushion 52 can include a lower surface 52a which preferably connects to an upper surface 48e of the seat frame module 48. Preferably, the seat frame module 48 is provided with a second set of holes 48d which align with a corresponding set of holes 52d provided on the lower surface 52a of the seat cushion 52. More preferably, each of these set of holes 48d, 52d consists of two holes. Additionally, the lower surface 52a of the seat cushion 52 can include a set of two clips 51 which are designed to be inserted into a set of two notches 49 provided on the upper surface 48e of the seat frame module 48.

Furthermore, the backrest cushion 54 can include a proximal surface 54a which connects to a front of backrest frame module 50. According to a preferred embodiment, the backrest cushion 54 is provided with a set of holes 54e on its proximal surface which are connectable to a corresponding set of holes 50e provided on the backrest frame module 50 with bolts and/or other mechanical fasteners. More preferably, each of these sets of holes 50e, 54e consists of at least four holes.

The backrest shell 56 can be connected to a rear of the backrest frame module 50. According to a preferred embodiment, the backrest shell 56 is provided with a set of holes 56f which is connectable to a corresponding set of holes 50f provided on the backrest frame module 50. As the set of holes 54e for the backrest cushion 54 are independent of, and separated from, the set of holes 56f of the backrest shell 56, it is understood that either one of the backrest cushion 54 or the backrest shell 56 can be removed/installed to the backrest frame module 50 without affecting the other.

Each of the mounting interface mentioned above preferably consist of at least one planar surface, which encourages simplicity and rapidity in assembling and disassembling the seat assembly. Preferably, the outer extremities of the mounting interfaces does not overlap with or interfere with the outer extremities of adjacent mounting interfaces, thereby facilitating and simplifying the replacement, removal and/or repair of modules. Optionally, at least one of the mounting interfaces may include an anti-wobbling fastening mechanism for reducing wobbling between modules, such as the mechanism described above for connecting the tripod module to the tripod mounting module, for example. Of course, it is understood that the term “mechanism” does not limit the anti-wobbling fastening mechanism to a piece of machinery. The term “mechanism” in the context of its use with the anti-wobbling mechanism can mean any configuration, interface, mounting, device, etc. used to reduce wobbling between two mounting interfaces and their modules. Preferably, the anti-wobbling fastening mechanism has a secondary surface which is perpendicular to the at least one planar surface of the mounting interface, and which has at least one fastener to secure the contact surfaces. This anti-wobbling fastening mechanism enhances the connection between two modules, for example, when their corresponding interfaces have to support oscillatory shear forces.

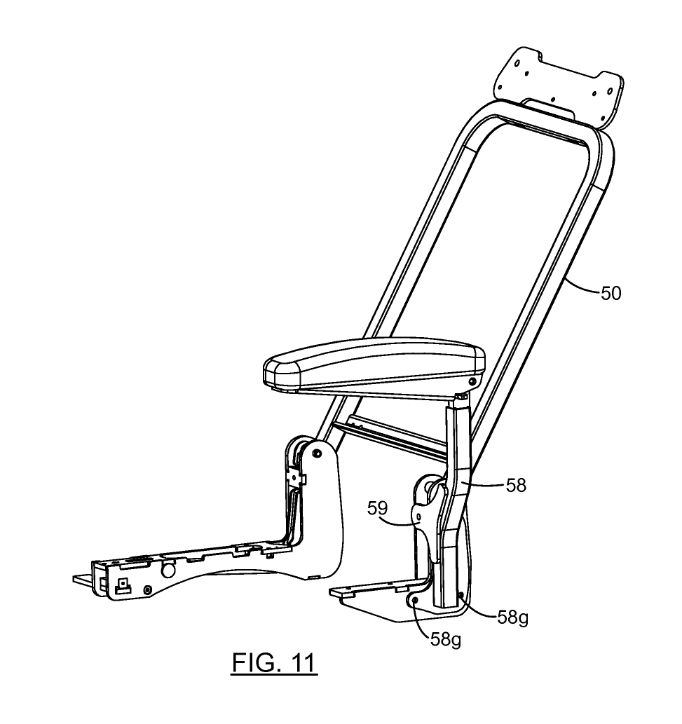

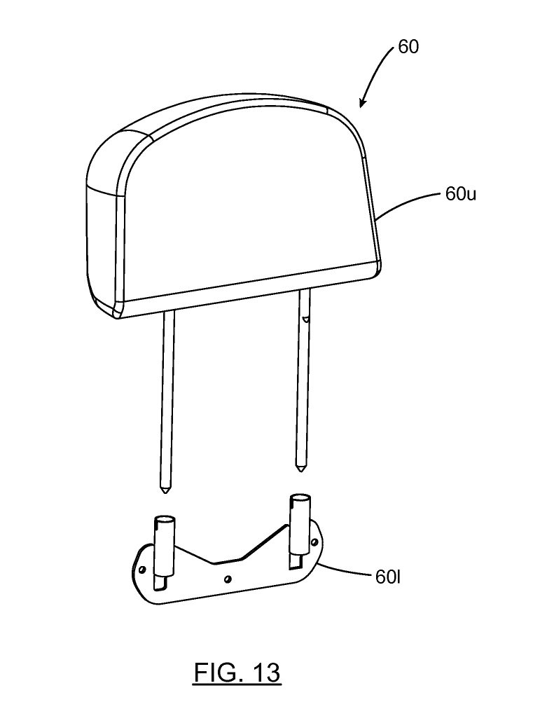

According to another preferred embodiment, and as shown in FIGS. 11 to 13, the seat group 4 may include additional optional modules such as an armrest module 58, a headrest module 60, or a footrest module 62, each of these modules having a functionality inherently described by their names. The armrest module 58 and the headrest module 60 can be easily fastened onto the backrest frame module 50 as comfort options, if desired. Preferably, the armrest module 58 is provided with a set of holes 58g which can be used to secure the armrest module 58 to the backrest frame module 50 via a corresponding set of holes 50g provided on a side of the backrest frame module 50 by using a mechanical fastener such as a bolt, for example (see FIG. 8). In securing the armrest module 58 in such a fashion, the armrest becomes stabilised and is better able to resist shear forces. More preferably, each of these set of holes 50g, 58g consists of at least three holes. The armrest module 58 may also comprise secondary planar surfaces kept in contact with at least one bolting surface 59, thereby providing an anti-wobbling fastening mechanism as described above. This anti-wobbling fastening mechanism is preferably a bolting surface 59 perpendicularly disposed with respect to the principal bolting surface 58g, the bolting surface 59 being bolted to the front of the backrest frame module 50, further stabilizing the armrest module 58 against shear forces. A footrest module 62 is also optionally connected to the tripod mounting module 8 via its interface 34, as explained above. Referring to FIG. 13, the headrest module 60 can consist of a lower portion 601 and an upper portion 60u. The lower portion 60l is preferably fastened to an interior surface of the backrest frame module 50 with bolts through three holes 50h (see FIG. 8). The upper portion 60u is preferably then inserted into the lower portion 60l and adjusted according to a desired height by known techniques.

Of course, the scope of the invention should not be limited by the preferred embodiments set forth in the examples, but should be given the broadest interpretation consistent with the description as a whole. Numerous modifications could be made to the above-described embodiments without departing from the scope of the invention, as apparent to a person skilled in the art.

1. A modular seat assembly for providing an independent functional partitioning of a modular seat in a vehicle cabin, the modular seat assembly comprising a mounting group of modules and a seat group of modules, the mounting group comprising modules being configured for being mounted to the vehicle cabin, and the seat group comprising modules being configured for assembling the modular seat, the seat group being connectable to the mounting group, each module having an independent function and comprising a mounting interface removably connecting each module to an adjacent module, wherein the modular seat assembly has a final functionality defined by a combination of the independent function of each module.

2. The modular seat assembly according to claim 1, wherein the mounting group comprises a wall-mounting module removably connectable to a vehicle wall for providing a wall-mounted configuration to the modular seat assembly.

3. The modular seat assembly according to claim 2, wherein the mounting group comprises a floor-mounting module removably connectable to a vehicle floor for providing a floor-mounted configuration to the modular seat assembly.

4. The modular seat assembly according to claim 3, wherein the mounting interface of each module of either the mounting group or the floor-mounting group comprises at least one planar surface, the at least one planar surface of each mounting interface connecting to a corresponding at least one planar surface of another mounting interface.

5. The modular seat assembly according to claim 1, wherein the mounting interface of each module of the mounting group and the seat group comprises mechanical fasteners for removably connecting the mounting interface of each module to a corresponding mounting interface of another module.

6. The modular seat assembly according to claim 5, wherein the mechanical fasteners are standard fasteners configured for adapting the modules and readying their mounting.

7. The modular seat assembly according to claim 1, wherein at least one mounting interface comprises an anti-wobbling fastening mechanism.

8. The modular seat assembly according to claim 7, wherein the anti-wobbling fastening mechanism comprises a secondary planar surface being perpendicular to an at least one planar surface of a corresponding mounting interface, the anti-wobbling fastening mechanism further comprising at least one fastener.

9. The modular seat assembly according to claim 5, wherein at least one of said mechanical fasteners comprises a tamper resistant fastener for fastening at least two modules through their respective mounting interfaces.

10. The modular seat assembly according to claim 1, wherein the mounting group comprises a positioning mechanism for height and rotational positioning of the modular seat assembly.

11. The modular seat assembly according to claim 3, wherein the mounting group comprises:
a tripod module connectable to a wall of the vehicle cabin;
a tripod mounting module connectable to the tripod module;
a floor-mounting module connectable to a floor of the vehicle cabin; and
a seat-supporting module connectable either to the tripod mounting module or the floor-mounting module for respectively providing a wall-mounted configuration or a floor-mounted configuration to the modular seat assembly.

12. The modular seat assembly according to claim 1, wherein the seat group comprises:
a platform;
a seat frame module connectable to the platform; and
a seat cushion connectable to the seat frame module.

13. The modular seat assembly according to claim 12, wherein the seat group further comprises:
a backrest frame module connectable to the platform;
a backrest cushion connectable to the backrest frame module; and
a backrest shell connectable to the backrest frame module.

14. The modular seat assembly according to claim 13, wherein the seat group further comprises:
an armrest module connectable to the backrest frame module;
a headrest module connectable to the backrest frame module; and
a footrest module connectable to a tripod mounting module.

15. The modular seat assembly according to claim 2, wherein the seat group comprises a positioning device for seat group longitudinal positioning, the positioning device being located on a wall-track when the mounting group is in the wall-mounted configuration.

16. The modular seat assembly according to claim 11, wherein the seat group comprises a positioning device for seat group longitudinal positioning, the positioning device being located inside the seat-supporting module in the floor-mounted configuration.

17. The modular seat assembly according to claim 1, wherein at least one module comprises at least two different configurations defining at least one ergonomic function, thereby providing the seat assembly with a choice of ergonomic function.

18. The modular seat assembly according to claim 2, wherein at least one mounting interface comprises an anti-wobbling fastening mechanism.

19. The modular seat assembly according to claim 3, wherein at least one mounting interface comprises an anti-wobbling fastening mechanism.

20. The modular seat assembly according to claim 4, wherein at least one mounting interface comprises an anti-wobbling fastening mechanism.
